(19) United States
(12) Patent Application Publication
(10) Pub. No.: US 2016/0098609 A1
(43) Pub. Date: Apr. 7, 2016

(54) A video analysis device and a method of operating a video analysis device

(71) Applicant: KONINKLIJKE PHILIPS N.V., Eindhoven (NL)

(72) Inventors: Tommaso GRITTI, Breda (NL); Gianluca MONACI, Eindhoven (NL); Franciscus Hendrikus VAN HEESCH, EINDHOVEN (NL)

(21) Appl. No.: 14/889,500

(22) PCT Filed: Apr. 28, 2014
(86) PCT No.: PCT/EP2014/058598

§ 371 Date: Nov. 6, 2015

(30) Foreign Application Priority Data
May 7, 2013 (EP) 13166740.4

(51) Int. Cl. G06K 9/20; H04N 5/247; H05B 37/02; H04N 7/18

(52) U.S. Cl. CPC G06K 9/2036; H04N 7/18; H04N 5/247; H05B 37/029

(57) ABSTRACT

A video analysis device (3), configured to receive video sequences of an environment within a field of view (8) of a camera (7), and to analyze the video sequences as regards behavior of persons present in the video sequences. The video analysis device is configured to determine a footprint (15) of at least one light source (9) illuminating an area within the field of view with coded light. The coded light carries a unique light source identification for each light source. Furthermore, the video analysis device is configured to receive association information associating at least one object (13) with the light source identification of each light source illuminating each object, and to determine an analysis area (17) within the field of view where said analysis of the video sequences is to be done. The determination is done for each object, and by means of the association information.

### FIELD OF THE INVENTION

The present invention relates to a video analysis device and to a method of operating a video analysis device.

### BACKGROUND OF THE INVENTION

Video analysis systems are used for many different purposes, one of these is audience measurements. Some examples of audience measurements are measuring dwell times at exhibition stands, measuring store traffic, such as the number of people entering and leaving a store and the traffic at different times of a day, measuring dwell times at product counters to assess the effectiveness of marketing displays, and measuring queuing at checkout counters in order to adapt the number of cashiers.

The installation of a video analysis system for a typical audience measurement, in the example of a shopping environment, inter alia comprises the following steps. A set of cameras is placed in the environment in which audience measurement is to be deployed. A technician connects to every available camera and defines an analysis area within its field of view, i.e. within the image. For each analysis area, a corresponding product code, or product group is defined, for one or more products associated with the analysis area. The video analysis system is initialized, and the statistics gathered for each analysis area are automatically associated with the corresponding product.

While apparently straightforward, in practice this procedure can be cumbersome, when a large number of cameras are installed, possibly with overlapping fields of view. Furthermore, at every instance at which the shop would have to be re-arranged, or even every time the products would be moved to another location, the configuration would have to be updated, and therefore the tedious manual area definition for each camera repeated.

WO 2013/054221 discloses a coded lighting system which is configured to detect an “object”, such as a person, within an area which is illuminated by one or more light sources emitting coded light, and to control the illumination on basis thereof. The detection is made by comparing subsequent images and discovering differences which are caused by an object that has entered the area or that has been moved within the area. However, there is no disclosure of associating analysis areas with products.

### SUMMARY OF THE INVENTION

It would be advantageous to simplify the manual association of analysis areas to their corresponding product groups.

To better address this concern, in a first aspect of the invention there is presented a video analysis device, configured to receive video sequences of an environment within a field of view of a camera, and to analyze the video sequences as regards behavior of persons present in the video sequences. The video analysis device is configured to determine a footprint of at least one light source illuminating an area within the field of view with coded light, which coded light carries a unique light source identification for each light source. Furthermore, the video analysis device is configured to receive association information associating at least one object with the light source identification of each light source illuminating each object, and to determine, for each object, and by means of said association information, an analysis area within said field of view where said analysis of the video sequences is to be done.

By employing the light sources emitting coded light, which carries a unique light source identification for each light source, it is possible for the video analysis device to determine individual footprints of the light sources, and it is possible to determine which, one or more, light source illuminates which object. By providing the video analysis device with the association information it is able to determine the analysis area. Thereby the manual configuration work has been reduced.

It should be noted that for the purposes of this application, the expression audience measurement will be used for any kind of measurement of how persons behave in the environment where the video analysis device is installed. In accordance with an embodiment of the video analysis device, it is further configured to assign results of the analysis within each analysis area to the associated object. Thereby it is simple to relate the result of the analysis to the relevant object.

According to another aspect of the invention there is provided an assembly comprising the video analysis device described above, and at least one of a camera and a light source. Thus, advantageously, the video analysis device is provided as one part in common with one or more of the other parts.

According to another aspect of the invention, there is provided a method of operating a video analysis device, comprising:
receiving video sequences of an environment within at least one analysis area constituting at least a portion of a field of view of a camera;
analyzing the video sequences as regards behavior of persons present in the video sequences; and
configuring the video analysis device by:
determining a footprint of at least one light source illuminating at least a portion of the field of view with coded light, which coded light carries a unique light source identification for each light source;
determining at least one analysis area on basis of said association information and said footprint.

This method provides advantages corresponding to those provided by the above-mentioned video analysis device.

In accordance with an embodiment of the method, the determination of at least one analysis area comprises:
receiving an association list comprising object codes and light source identifications, wherein each object code is associated with the light source identification of each light source illuminating the corresponding object; and determining, by means of said association list, said at least one analysis area.

According to another aspect of the invention, there is provided a method of configuring a video analysis system comprising a camera and a video analysis device connected with the camera, the method comprising:
detecting an object code at an object;
detecting coded light illuminating the object, wherein the coded light contains a unique individual light source identification for each light source emitting the coded light;
associating the light source identification with the object code and providing the video analysis system with that association information;
determining, at the video analysis system, a footprint of the light source within a field of view of the camera; and
determining an analysis area within the field of view of the camera on basis of said association information and said footprint.

Further, there is provided a video analysis system comprising at least one video analysis device as described above, several light sources configured to emit coded light, and each having a unique individual light source identification, and a commissioning device configured to detect object codes of objects, and light source identifications embedded in light illuminating the objects, and to generate the association information.

### BRIEF DESCRIPTION OF THE DRAWINGS

The invention will now be described in more detail and with reference to the appended drawings in which:

FIG. 1 is a schematic perspective view of an embodiment of a video analysis system according to the present invention;

FIG. 2 is a schematic view from above illustrating different areas defined by the video analysis system of FIG. 1; and

FIGS. 3 and 4 are schematic block diagrams of possible embodiments of assemblies according to the present invention.

### DESCRIPTION OF EMBODIMENTS

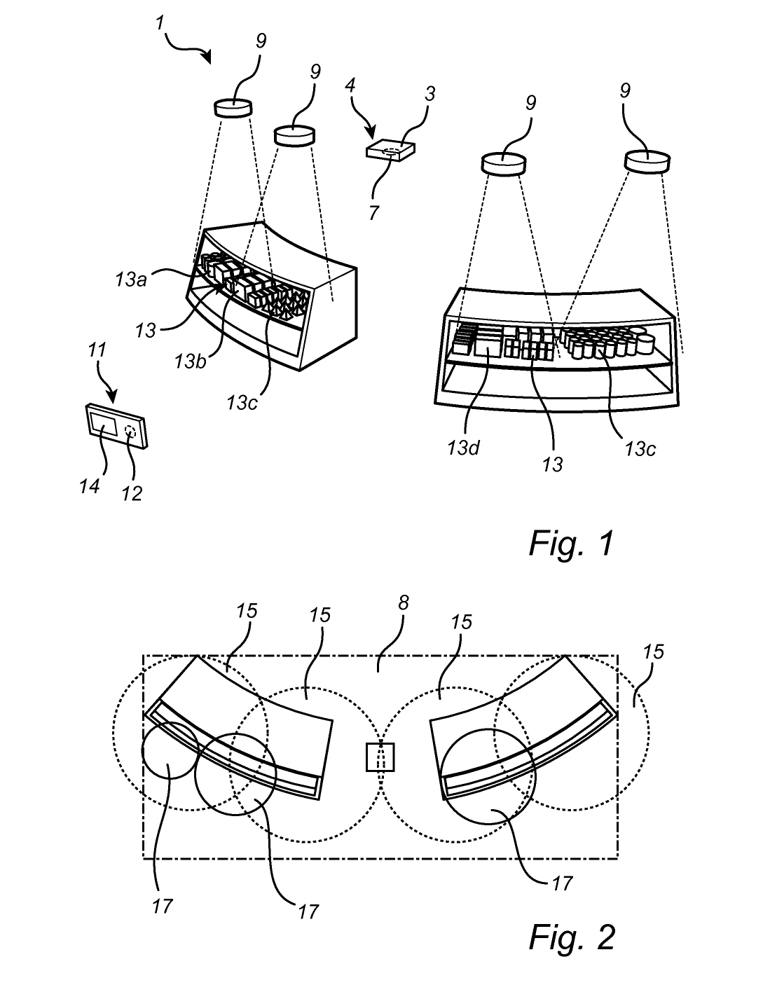

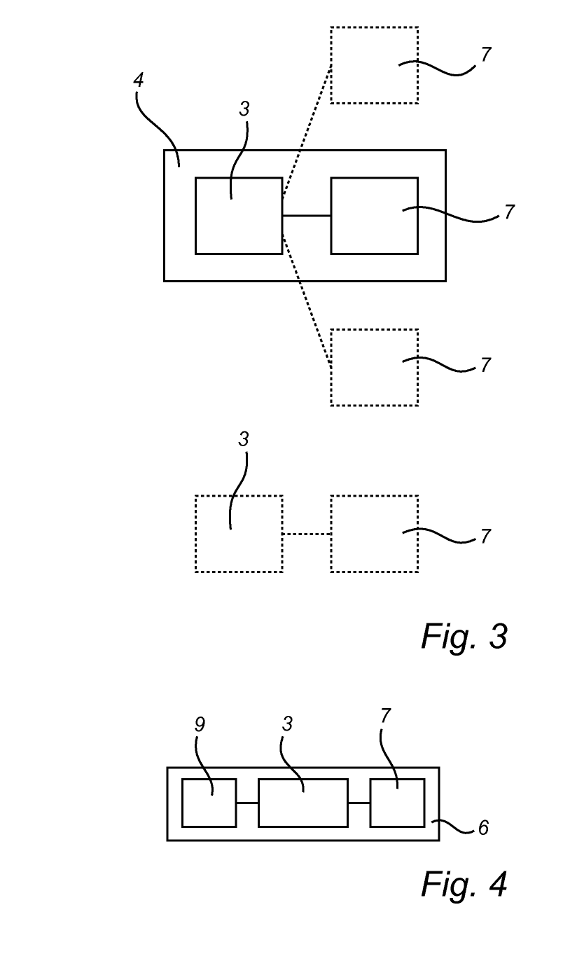

A basic purpose of the present devices and methods is to perform audience measurements in an environment where objects are placed and it is desired to measure the behavior of persons entering the environment related to the objects. According to an embodiment of the video analysis system 1 it comprises at least one video analysis device 3, several cameras 7, several light sources, such as luminaires, 9, and a product and lighting commissioning device (PLCD) 11. Different embodiments are feasible, with different combinations of video analysis devices 3 and cameras 7. More particularly, as indicated in FIG. 3, according to one embodiment there is provided separate assemblies having one video analysis device 3, and one camera 7 connected with the video analysis device 3, each. Data is collected from each video analysis device 3. Preferably, the camera 7 is integrated with the video analysis device 3 in the same housing, thus forming a combined assembly 4, as indicated in FIGS. 1 and 3. According to another embodiment, as also indicated in FIG. 3, there is one video analysis device 3, and several cameras 7, all connected to the video analysis device 3 either via wired or wireless connections. Other structures are possible as well. In the first mentioned embodiment, separate integrated assemblies can be provided, avoiding wiring or wireless communication between several cameras and the video analysis device, while in the latter embodiment the cost of several video analysis devices is saved. Depending on the environment both embodiments are applicable, and data is collected from the single video analysis device 3.

The video analysis system 1 is installed in an environment, such as a store, where it is of interest to measure the behavior of persons, such as customers, in connection with objects, such as products for sale, 13, which are illuminated by the light sources 9. Each light source 9 is configured to emit coded light, and has a unique individual light source identification (ID). Each one of the cameras 7 has a field of view 8 covering a different part of the store, possibly with some overlap.

According to a further embodiment of the video analysis system the video analysis device 3, a camera 7 and a light source 9 are integrated into an individual assembly 6. As a further alternative, the assembly contains a light source and a video analysis device 3, but no camera 7.

Typical relevant audience measurements performed by the video analysis device 3 in a store provide information about one or more of dwelling time, interaction with products, travelled paths within the store, etc. In order to be able to provide reliable output of the measurements, it must be determined what parts of the field of view 8 of each camera 7 are associated with what objects 13, as will be described below.

The video analysis system 1 is operated as follows. First an installation phase is carried out, comprising installing, if not already in place, a lighting system, which comprises the light sources 9 capable of being modulated to transmit desired coded light information; commissioning the lighting system in such a way that all light sources are assigned a unique code; installing the cameras 7, either in each light source 9, in a subset of the light sources 9, or independently thereof.

The video analysis device 3, comprising software and hardware, is installed and connected with the cameras 7. It should be noticed that, in this phase, no commissioning of the video analysis device 3 is required with regards to product placement, entry/exit points or queuing areas. The PLCD 11 is provided.

Second an operational phase is carried out, e.g. by retail personnel, once the system 1 is initially installed, or once a new product configuration is in place. The operational phase comprises, for every relevant product category 13a-13e, pointing with the PLCD 11 at a product area where the relevant product category 13a-13e is located, wherein the PLCD 11 detects the product code by means of, for example, reading a bar code, receiving it via Near Field Communication (NHC), reading QR/AR tags, performing object recognition, or receiving it via human input. Typically, the PLCD includes a suitable detector 12, such as a photo sensor, a camera, a NFC detector, etc., and a user interface 14 comprising a display and a data input unit.

Furthermore, the operational phase comprises detecting, with the PLCD 11, light source identifications (IDs) of all, i.e. one or more, light sources 9 illuminating the products 13. This can be achieved either by means of a photodiode or a camera 12.

Furthermore, the operational phase comprises generating an association list, or adding an item to it, by means of the PLCD 11. The association list contains the particular combinations of light source IDs and detected product codes for the store. Then the PLCD 11 sends the association list to the video analysis device 3. It is unlikely that no light source ID is associated with a product, but if that would happen, some light source 9 will simply have to be arranged, or the products 13 moved to an illuminated area. There also is a minor likelihood that two product categories 13a-13e are associated with the same combination of light source IDs. In this case, several options can be conceived, such as adjusting the lighting direction or product location, or displaying a camera view and allow to manually refining the automatic analysis area selection.

Furthermore, the operational phase comprises computing, for every camera 7, the footprint 15 of the light emitted by each coded light source 9 visible in the field of view 8 of the camera 7. The footprints 15 are detected in the image generated by the camera 7, by means of image processing which is known per se, performed by control circuitry of the camera 7 as such or by the video analysis device 3. Then the light footprints 15 detected in the camera view are further analyzed, by the video analysis device 3, searching for the particular light source IDs or combinations of IDs listed in the association list. Every area in the image for which such a light source ID or ID combination is found is associated to the corresponding product 13. Thereby, the video analysis device 3 is able to determine an analysis area 17 for each product, where the audience measurements are to be performed.

Consequently, by using the PLCD 11 to perform the identification of product codes and light source IDs and combining them to generate the association list, and having the video analysis device(s) 3 apply the association list for determining the analysis area(s), the video analysis system 1 has been started up. Then the video analysis system 1 performs audience measurements and assigns the resulting data for each analysis area 17 to the corresponding product. If a product rearrangement is executed, i.e. a product (or several products) is moved, exchanged, added, or the like, all that is needed to do is to make an update of the association list by means of the PLCD and forward the association list to the video analysis device(s) 3 for a corresponding update of the analysis area(s).

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A video analysis device, configured
to receive video sequences of an environment within a field of view of a camera, and
to analyze the video sequences as regards behavior of persons present in the video sequences,
wherein the video analysis device is configured to run a configuration sequence, during which the video analysis device is configured to obtain a footprint of at least one light sourced illuminating an area within the field of view with coded light, the footprint being determined by one of the camera and the video analysis device by means of identifying the coded light emitted by the light source and being present in an image generated by the camera, which coded light carries a unique light source identification for each light source;
characterized in that
the video analysis device is farther configured
to receive association information associating at least one product with the light source identification of each light source illuminating the product; and
to determine, for each product, and by means of said association information and the footprint of each light source represented in the association information, an analysis area within said field of view where said analysis of the video sequences is to be done.

2. The video analysis device according to claim 1, further configured to assign, for the each product, results of the analysis within each analysis area to the product.

3. An assembly comprising the video analysis device according to claim 2, and at least one of a camera and a light source.

4. A method of operating a video analysis device, comprising:
receiving video sequences of an environment within at least one analysis area constituting at least a portion of a field of view of a camera;
analyzing the video sequences as regards behavior of persons present in the video sequences; and
configuring the video analysis device by:
obtaining a footprint of at least one light source illuminating at least a portion of the field of view with coded light, the footprint being determined by one of the camera and the video analysis device by means of identifying the coded light emitted by the light source and being present in an image generated by the camera, which coded light carries a unique light source identification for each light source;
characterized by
receiving association information associating at least one product with the light source identification of each light source illuminating the product; and
determining at least one analysis area on basis of said association information and said footprint.

5. The method of operating a video analysis device according to claim 4, said determining at least one analysis area comprising:
receiving an association list comprising object codes and light source identifications, wherein each object code is associated with the light source identification of each light source illuminating the corresponding object; and determining, by means of said association list, said at least one analysis area.

6. A method of configuring a video analysis system comprising a camera and a video analysis device connected with the camera, the method comprising:
detecting an product code at a product;
detecting coded light illuminating the product, wherein the coded light contains a unique individual light source identification for each light source emitting the coded light;
associating the light source identification with the product code and providing the video analysis system with that association information;
determining, at the video analysis system, a footprint of the light source within a field of view of the camera, by means of identifying the coded light emitted by the light source and being present in an image generated by the camera; and
determining an analysis area within the field of view of the camera on basis of said association information and said footprint.

7. The method according to claim 6, said determining an analysis area comprising:
receiving an association list comprising object codes and light source identifications, wherein each object code is associated with the light source identification of each light source illuminating the corresponding object; and determining, by means of said association list, said at least one analysis area.

8. A video analysis system comprising at least one video analysis device according to claim 2, several light sources configured to emit coded light, and each having a unique individual light source identification, and a commissioning device configured to detect object codes of objects, and light source identifications embedded in light illuminating the objects, and to generate the association information.

9. The video analysis system according to claim 8, further comprising at least one camera.
